(19) United States
(12) Patent Application Publication
(10) Pub. No.: US 2006/0216123 A1
(43) Pub. Date: Sep. 28, 2006

(54) Flat bit sphere named the V-back paddlesphere bit

(76) Inventor: Brett Whitlock Burdick, Clinton, CT (US)

Correspondence Address: Brett Burdick, 16 Country Village Lane, Clinton, CT, 06413, US

(21) Appl. No.: 11/090,265

(22) Filed: Mar. 24, 2005

(51) Int. Cl. B23B 51/00

(52) U.S. Cl. 408/211

(57) ABSTRACT

It is a flat drill bit or blade, which could have 1 or 2 blades with a sphere to eliminate most jerking and grabbing, for more efficient drilling.

Name: Flat bit sphere Named the V-back Paddlesphere bit

United States Patent

Inventer: Brett Whitlock Burdick

Flat drill bit with a sphere for better Balance and anti grab and jerk.

V-Back Paddlesphere

Inventor: Burdick; Brett W. (16 country Village Lane, Clinton Conn. 06413)

Appl. No. 11/090,265

Filed:

Field of search-U.S. Pat. No. 4,189,266 5,452,970 5,626,446 4,527,643

### SPECIFICATION

1. I Brett Whitlock Burdick have invented a new flat bit that is v-back to avoid Contact with the hole surface. It could have a sphere around it or not.

DRAWING 1. Of 1.

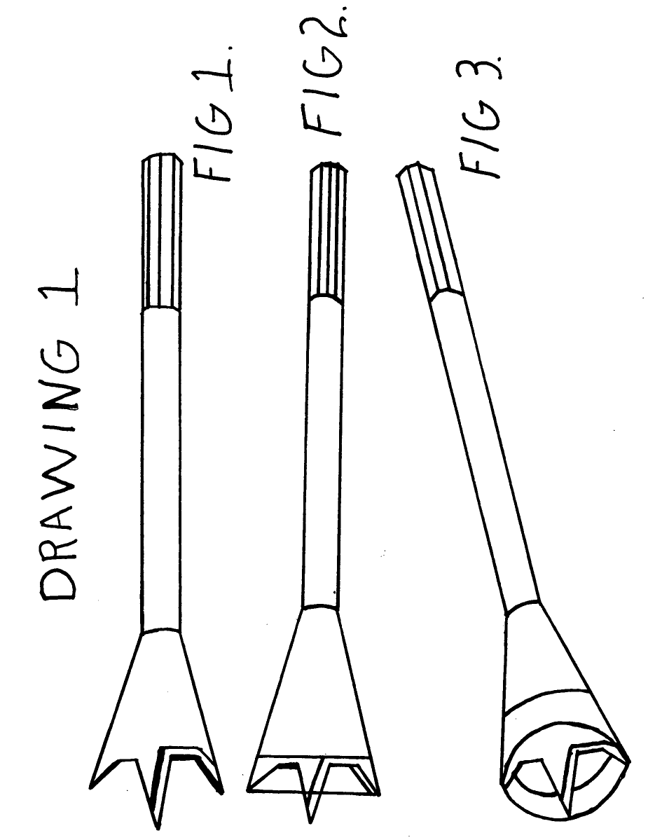

FIG. 1. Is the front view showing the flat bit tapered back for no hole contact without the sphere.

FIG. 2. Is the flat bit with the v-back with the sphere.

FIG. 3. Is the slight angeled view of the V-Back paddlesphere bit.

What is claimed is:

1. Said claim 1 that this bit with the sphere could have 1 or 2 blades.

2. Said claim 2 that a sphere is added for anti torque, grab and jerk.

3. Said claim 3 that after the sphere head it tapers to relieve so flat part of the blade avoids material therefore called the v-back paddlesphere

4. Said claim 4 that since it is an anti grab design drill sphere bits could be bigger.

5. Said claim 5 that the sphere could be curved like a cup to help in avoiding all contact with wall surfaces.

6. Said claim 6 that the sphere could also have blade teeth.

7. Said claim 7 that the sphere could be slightly narrower then the paddle part of the blade FIG. 4.
